(19) United States
(12) Patent Application Publication
(10) Pub. No.: US 2012/0314091 A1
(43) Pub. Date: Dec. 13, 2012

(54) REAL-TIME AUDIO/VIDEO TRANSMISSION DEVICE

(75) Inventors: CHEN-PING YANG, Taipei City (TW); ALLEN CHANG, Taipei City (TW)

(73) Assignee: DIGILIFE TECHNOLOGIES CO., LTD., Taipei City (TW)

(21) Appl. No.: 13/337,557

(22) Filed: Dec. 27, 2011

(30) Foreign Application Priority Data
Jun. 10, 2011 (TW) 100210559

(51) Int. Cl. H04N 5/225

(52) U.S. Cl. 348/207.1; 348/E05.024

(57) ABSTRACT

A real-time audio/video transmission device is wirelessly linked to a smart handheld device for transmitting an AV signal to the latter for playing, and includes a central processing unit for receiving and converting image and sound signals into an AV signal; an image capture section electrically connected to the CPU for capturing and converting an external image into an image signal for transmitting to the CPU; a sound capture unit electrically connected to the CPU for capturing and converting an external sound into a sound signal for transmitting to the CPU; and a wireless transmission section electrically connected to the CPU for receiving the AV signal and wirelessly transmitting the latter to the smart handheld device. With the smart handheld device, the real-time AV transmission device does not require a display and can have reduced manufacturing cost and be monitored from a remote location while provides diversified functions.

### CROSS-REFERENCE TO RELATED APPLICATION

This non-provisional application claims priority under 35 U.S.C. §119(a) on Patent Application No(s). 100210559 filed in Taiwan, R.O.C. on Jun. 10, 2011, the entire contents of which are hereby incorporated by reference.

### FIELD OF THE INVENTION

The present invention relates to a real-time audio/video transmission device, and more particularly to a real-time audio/video transmission device that can be wirelessly linked to a smart handheld device and can therefore omit a display therefrom to reduce the manufacturing cost while enabling remote monitoring and diversified functions thereof.

### BACKGROUND OF THE INVENTION

A conventional camcorder usually includes a camera and a display movably arranged at one lateral side of the camera. When using the camcorder to shoot pictures, the display is pivotally turned outward from the camera, and the camera is used to capture still or dynamic images and sounds or used to play back the captured images. The images being captured are shown via the display to complete the function of shooting pictures.

Since the conventional camcorder is equipped with a display, it requires higher manufacturing cost and is sold at a high price. Further, with the conventional camcorder, a user has to always stay with the camcorder for capturing still or dynamic images and sounds. Therefore, the convenience in using the conventional camcorder is low.

It is therefore desirable to develop a device that has reduced manufacturing cost and can be remotely monitored while providing diversified functions.

### SUMMARY OF THE INVENTION

In view of the drawbacks in the prior art camcorder, it is tried by the inventor to develop an improved real-time audio/video (AV) transmission device that has reduced manufacturing cost, enables remote monitoring, and provides diversified functions.

It is therefore a primary object of the present invention to provide a real-time AV transmission device that can be wirelessly linked to a smart handheld device and can therefore omit a display therefrom to reduce the manufacturing cost while enabling remote monitoring and diversified functions thereof.

To achieve the above and other objects, the real-time AV transmission device according to the present invention is wirelessly linked to at least one smart handheld device for transmitting an AV signal thereto, and the smart handheld device includes a player module for playing the AV signal. The real-time AV transmission device includes a central processing unit (CPU) for receiving an image signal and a sound signal, and converting the received image and sound signals into an AV signal; an image capture section electrically connected to the CPU and used to capture an external image, convert the captured image into an image signal, and transmit the image signal to the CPU; a sound capture unit electrically connected to the CPU and used to capture an external sound, convert the captured sound into a sound signal, and transmit the sound signal to the CPU; and a wireless transmission section electrically connected to the CPU and used to receive the AV signal from the CPU and wirelessly transmit the received AV signal to the smart handheld device.

In the present invention, the image capture section includes a shooting unit and a light emitting unit, or a combination thereof.

In the present invention, the wireless transmission section includes a wireless network transmission unit and a Bluetooth transmission unit, or a combination thereof.

According to the present invention, the real-time AV transmission device further includes a memory unit electrically connected to the CPU and used to store the AV signal.

According to the present invention, the real-time AV transmission device further includes a sound output unit electrically connected to the CPU.

According to the present invention, the real-time AV transmission device further includes a data input/output unit electrically connected to the CPU.

According to the present invention, the real-time AV transmission device further includes a control unit electrically connected to the CPU.

According to the present invention, the real-time AV transmission device further includes a power unit electrically connected to the CPU.

According to the present invention, the smart handheld device may be a smart mobile phone, a smart personal digital assistant (PDA), a portable computer, or a tablet computer.

With the above arrangements, the real-time AV transmission device of the present invention takes advantage of the smart handheld device to omit a display therefrom, so as to have reduced manufacturing cost while enabling remote monitoring and diversified functions thereof.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram showing a basic configuration of a real-time audio/video (AV) transmission device according to an embodiment of the present invention;

FIG. 2 schematically shows the real-time AV transmission device of the present invention in use; and

FIG. 3 is another view showing the use of the real-time AV transmission device of the present invention.

### DETAILED DESCRIPTION OF THE PREFERRED EMBODIMENTS

The present invention will now be described with a preferred embodiment thereof and with reference to the accompanying drawings.

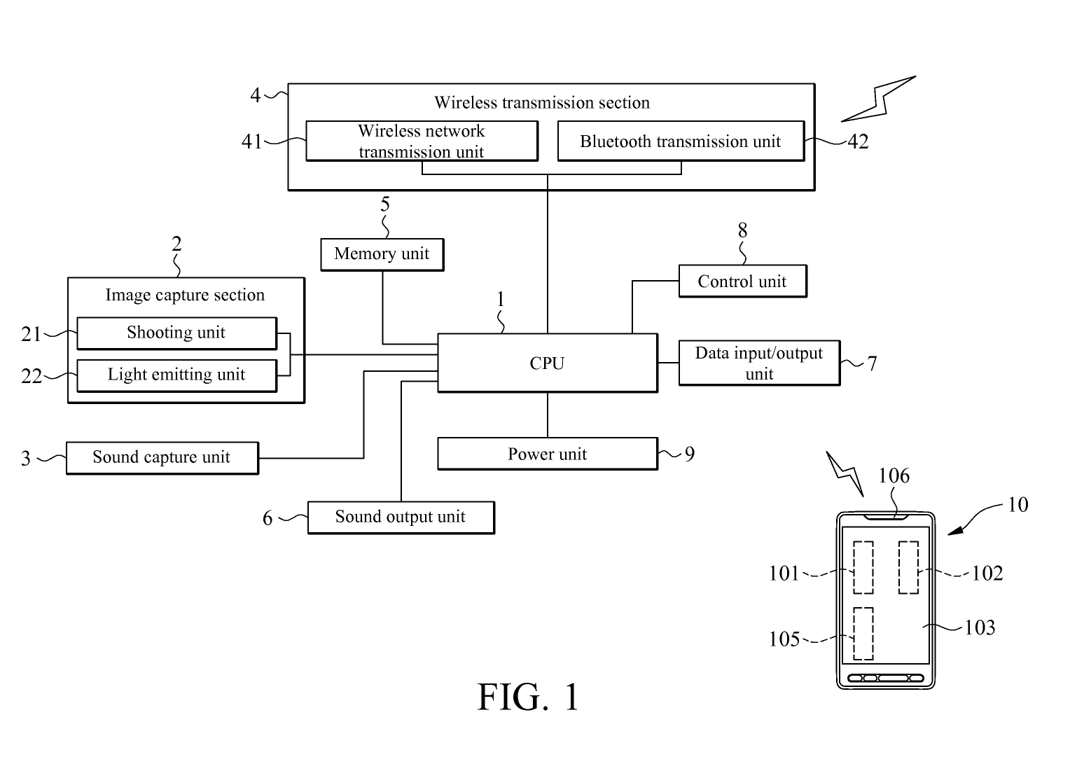

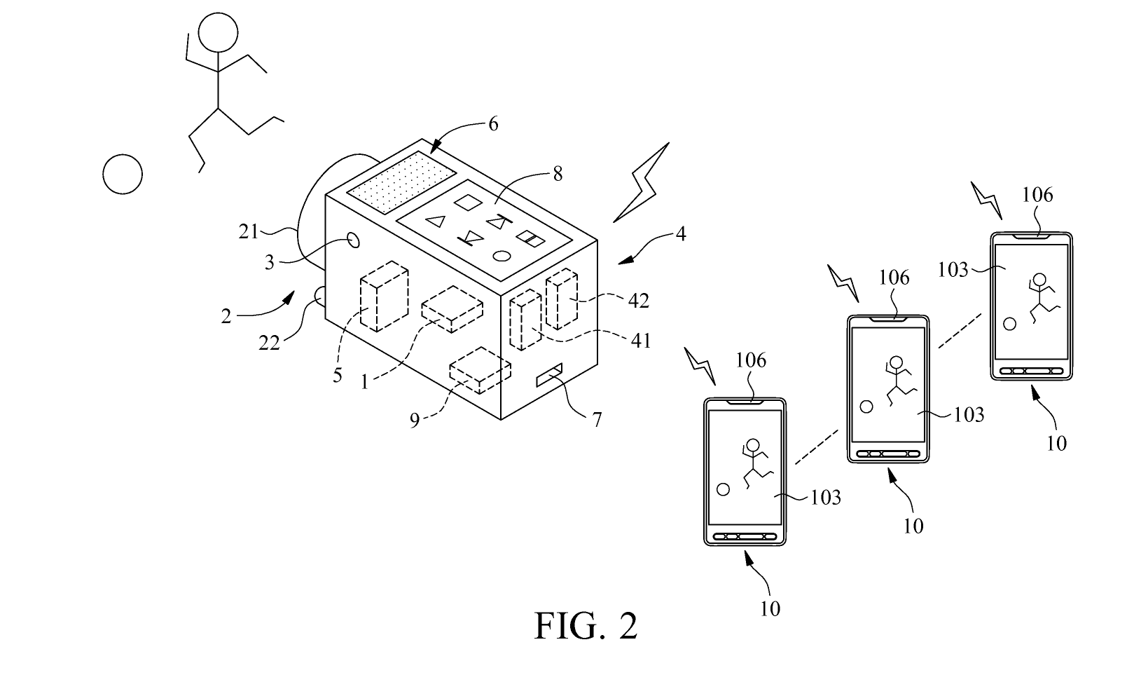

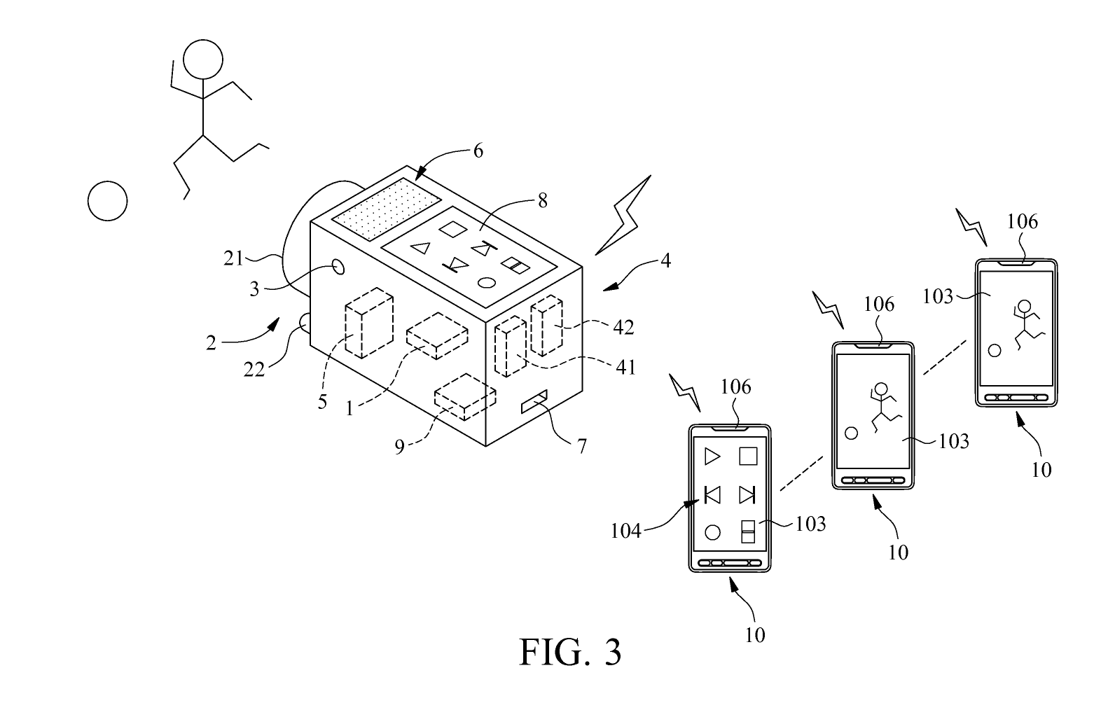

Please refer to FIG. 1 that is a block diagram showing a basic configuration of a real-time audio/video (AV) transmission device according to an embodiment of the present invention, and to FIG. 2 that schematically shows the real-time AV transmission device of FIG. 1 in use. As shown, the present invention can be used with a smart handheld device 10, which has become very popular among consumers and may be a smart mobile phone, a smart personal digital assistant (PDA), a portable computer, a tablet computer or the like. The currently commercially available smart handheld devices 10 all include a display 103, a speaker 106 and a memory unit 105, and are usually equipped with a wireless network transmission unit 101, a Bluetooth transmission unit 102, or a combination thereof. Therefore, by taking advantage of the existing functions of the popular smart handheld devices 10, the real-time AV transmission device of the present invention is configured to include a central processing unit (CPU) 1, an image capture section 2, a sound capture unit 3, and a wireless transmission section 4. Wherein, the central processing unit 1 may be a microprocessor for receiving and converting image signals and sound signals into AV signals. The image capture section 2 is electrically connected to the CPU 1, and is used to capture external images, convert the captured images into image signals, and transmits the image signals to the CPU 1. The sound capture unit 3 can be a microphone electrically connected to the CPU 1, and is used to capture external sounds, convert the captured sounds into sound signals, and transmits the sound signals to the CPU 1. The wireless transmission section 4 is electrically connected to the CPU 1 for receiving AV signals from the CPU 1 and wirelessly transmitting the AV signals to a smart handheld device 10. In the present invention, the wireless transmission section 4 of the real-time AV transmission device can be wirelessly linked to the wireless network transmission unit 101 or the Bluetooth transmission unit 102 of at least one smart handheld device 10 for transmitting the AV signals thereto. While there are three smart handheld devices 10 shown in FIG. 2, it is understood the real-time AV transmission device of the present invention may be wirelessly linked to only one, two, or more than three smart handheld devices 10. The smart handheld devices 10 can display or play the received AV signals in real time via their respective display 103, speaker 106 and player module 104 (see FIG. 3). Further, the AV signals can be stored in the memory unit 105 of the smart handheld device(s) 10, allowing a user to repeat playing the AV signals on the smart handheld device(s). With these arrangements, the real-time AV transmission device of the present invention can utilize the display of the smart handheld device without the necessity of having a display provided with the real-time AV transmission device. By doing this, it is possible to reduce the manufacturing cost of the real-time AV transmission device and to remotely monitor the images and sounds captured by the real-time AV transmission device via the smart handheld device(s), making the real-time AV transmission device diversified in function.

Thus, when using the real-time AV transmission device of the present invention to capture images, the user does not need to always stay with the device but can monitor the captured images at a nearby or a distant location via a smart handheld device. In the case of monitoring the captured images from a nearby location, such as in a car, the real-time AV transmission device may serve as an event data recorder, and a backseat passenger may monitor the captured images via a smart handheld device. In the case of monitoring the captured images from a remote location, such as at the site of a game or a show, the real-time AV transmission device may be mounted to a location closer to the site of the game or the show, and the user may conveniently watch the game or the show at a somewhat distant location via a smart handheld device without the need of paying higher cost to secure a front seat that is not easily available.

FIG. 3 is another view showing the use of the real-time AV transmission device of the present invention. As shown, when a plurality of smart handheld devices 10 is linked to the real-time AV transmission device of the present invention, one of the smart handheld devices 10 may utilize a built-in player module 104 thereof to remotely control or actuate different functions of the real-time AV transmission device, such as power on/off, focusing and zooming of a lens of the image capture section, recording function on/off, and the like.

Please refer to FIGS. 1 to 3 at the same time.

The image capture section 2 of the real-time AV transmission device includes a shooting unit 21, a light emitting unit 22, or a combination thereof. The shooting unit 21 may be a lens with a CCD (charge coupled device) sensor or a CMOS (complementary metal-oxide-semiconductor) sensor, and having the zooming function for shooting both still and dynamic images. In the event of insufficient light source at the shooting site, the light emitting unit 22, which may be a light emitting diode (LED), may serve as an aid in shooting.

The wireless transmission section 4 includes a wireless network transmission unit 41, a Bluetooth transmission unit 42, or a combination thereof. A user may selectively use one of the wireless network transmission unit 41 and the Bluetooth transmission unit 42 according to different situations. For example, when the real-time AV transmission device is used in the vicinity of the smart handheld device 10, the user may wirelessly link the Bluetooth transmission unit 42 of the real-time AV transmission device to the Bluetooth transmission unit 102 of the smart handheld device 10. On the other hand, when the real-time AV transmission device is used at a location quite distant from the smart handheld device 10, the user may wirelessly link the wireless network transmission unit 41 of the real-time AV transmission device to the wireless network transmission unit 101 of the smart handheld device 10.

The real-time AV transmission device may further include a memory unit 5, which may be a memory and is electrically connected to the CPU 1. The memory unit 5 is used to store the AV signals, so that the user using the real-time AV transmission device to shoot may repeat viewing or watching the AV signals later via the smart handheld device 10.

The real-time AV transmission device may further include a sound output unit 6, which may be a speaker and is electrically connected to the CPU 1. The sound output unit 6 may output sound when the AV signals are replayed via the smart handheld device 10.

The real-time AV transmission device may further include a data input/output unit 7, which may be one of various types of connection ports and is electrically connected to the CPU 1. Via the data input/output unit 7, other AV data may be input to the real-time AV transmission device and then played via the smart handheld device 10. The data input/output unit 7 also allows output of the AV signals obtained through shooting with the real-time AV transmission device to other electronic devices (not shown), such as a hard disk, a memory card and the like.

The real-time AV transmission device may further include a control unit 8, which may be a set of keys and is electrically connected to the CPU 1. Via the control unit 8, the user may directly control or actuate different functions of the real-time AV transmission device, such as power on/off, focusing and zooming of the lens of the image capture section, recording function on/off, and the like.

The real-time AV transmission device may further include a power unit 9 electrically connected to the CPU 1 for supplying power to all elements in the real-time AV transmission device. The power unit 9 may be an internal power supply or an external power supply, depending on actual need in use. An internal power supply may be, for instance, a general battery or a rechargeable battery; and an external power supply may be, for instance, a power generator or an outlet power source.

With the above arrangements, the present invention is novel, improved, and industrially valuable. The present invention is novel and improved because the real-time AV transmission device can be wirelessly linked to a smart handheld device, so that a display can be omitted therefrom to reduce the manufacturing cost and the captured images can be remotely monitored via the smart handheld device, making the real-time AV transmission device diversified in function. The present invention is industrially valuable because products derived therefrom would no doubt fulfill the current market demands.

The present invention has been described with a preferred embodiment thereof and it is understood that the embodiment is illustrated only to enable easy description of the present invention and not intended to restrict the same in any way, and that many changes and modifications in the described embodiment can be carried out without departing from the scope and the spirit of the invention that is intended to be limited only by the appended claims.

What is claimed is:

1. A real-time audio/video (AV) transmission device, being wirelessly linked to at least one smart handheld device for transmitting an AV signal thereto and the smart handheld device including a player module for playing the AV signal, comprising:
a central processing unit (CPU) for receiving an image signal and a sound signal, and converting the received image and sound signals into an AV signal;
an image capture section being electrically connected to the CPU and used to capture an external image, convert the captured image into an image signal, and transmit the image signal to the CPU;
a sound capture unit being electrically connected to the CPU and used to capture an external sound, convert the captured sound into a sound signal, and transmit the sound signal to the CPU; and
a wireless transmission section being electrically connected to the CPU and used to receive the AV signal from the CPU and wirelessly transmit the received AV signal to the smart handheld device.

2. The real-time AV transmission device as claimed in claim 1, wherein the image capture section includes a shooting unit and a light emitting unit, or a combination thereof.

3. The real-time AV transmission device as claimed in claim 1, wherein the wireless transmission section includes a wireless network transmission unit and a Bluetooth transmission unit, or a combination thereof.

4. The real-time AV transmission device as claimed in claim 1, further comprising a memory unit being electrically connected to the CPU for storing the AV signal therein.

5. The real-time AV transmission device as claimed in claim 1, further comprising a sound output unit being electrically connected to the CPU.

6. The real-time AV transmission device as claimed in claim 1, further comprising a data input/output unit being electrically connected to the CPU.

7. The real-time AV transmission device as claimed in claim 1, further comprising a control unit being electrically connected to the CPU.

8. The real-time AV transmission device as claimed in claim 1, further comprising a power unit being electrically connected to the CPU.

9. The real-time AV transmission device as claimed in claim 1, wherein the smart handheld device is selected from the group consisting of a smart mobile phone, a smart personal digital assistant (PDA), a portable computer, and a tablet computer.
